(19) United States
(12) Patent Application Publication
(10) Pub. No.: US 2021/0076748 A1
(43) Pub. Date: Mar. 18, 2021

(54) TOOL FOR CLEANING ELECTRIC HEATING SMOKING DEVICE

(71) Applicant: SHENZHEN ROYAL TOBACCO INDUSTRIAL LTD, Shenzhen (CN)

(72) Inventors: BIN CHEN, Shenzhen (CN); YONG-HUI LIN, Shenzhen (CN); HONG-YI MAO, Shenzhen (CN)

(21) Appl. No.: 17/033,950

(22) Filed: Sep. 28, 2020

Related U.S. Application Data
(63) Continuation of application No. PCT/CN2019/079904, filed on Mar. 27, 2019.

(30) Foreign Application Priority Data
Apr. 4, 2018 (CN) 201810301891.2

(51) Int. Cl. A24F 40/85; B08B 1/00; B08B 1/04; B08B 9/045; A46B 13/02; A46B 13/00

(52) U.S. Cl. CPC A24F 40/85; B08B 1/002; B08B 1/04; A46B 2200/3013; B08B 9/045; A46B 13/02; A46B 13/001; B08B 1/008

(57) ABSTRACT

The present application provides a tool for cleaning an electric heating smoking device. The electric heating smoking device includes an accommodating cavity for accommodating a smoking stick. The tool includes a bracket configured to be inserted into the accommodating cavity; an electric motor configured to drive the bracket to move along an inner wall of the accommodating cavity; and a cleaning unit disposed on the bracket.

### CROSS-REFERENCE TO RELATED APPLICATIONS

This application claims priority of China Patent Application No. 201810301891.2, filed on Apr. 4, 2018, entitled “TOOL FOR CLEANING ELECTRIC HEATING SMOKING DEVICE”, the content of which are hereby incorporated by reference in its entirety. This application is a continuation under 35 U.S.C. § 120 of international patent application PCT/CN2019/079904, filed on Mar. 27, 2019, the content of which is also hereby incorporated by reference in its entirety.

### TECHNICAL FIELD

The present disclosure relates to cleaning tools for smoking devices, and more particularly, to tools for cleaning electric heating smoking devices.

### BACKGROUND

The heat-not-burn aerosol-generating products have been widely used in the field of novel tobacco. Such a heating type aerosol-generating product generates aerosol by transferring heat from a heat source to aerosol-generating material. During smoking, a user inhales volatile compounds that absorb heat and are released from the aerosol-generating material, and the air entraining the volatile compounds. The heating type aerosol-generating product reduces the known harmful smoke components produced by the combustion and thermal degradation of tobacco in conventional cigarettes.

In this novel heat-not-burn tobacco product, an elongated heater is usually inserted into a smoking stick with a shape similar to an ordinary cigarette, or the smoking stick is directly placed in a tubular heater, so that the smoke-generating material is heated. However, solids inside the smoking stick are easy to fall off and form residues. Moreover, as natural tobacco leaves and other smoke-generating materials are used in producing the smoke-generating material, a small amount of oily liquid substances including tar may seep from the smoking stick during the heating process. These liquid substances could remain in the accommodating cavity of the smoking stick and on the heater of the smoking device. If not removed in time, these liquid substances may form deposits during the repeated use of the smoking device. The deposits affect the heating performance of the heater and may crack into odorous substances, which will greatly affect the subsequent smoking taste.

### SUMMARY

The present disclosure provides a tool for cleaning an electric heating smoking device. The electric heating smoking device includes an accommodating cavity. The tool includes a bracket configured to be inserted into the accommodating cavity, an electric motor configured to drive the bracket to move along an inner wall of the accommodating cavity, and a cleaning unit disposed on the bracket.

In an embodiment, the cleaning unit includes at least one of an adsorbing material and bristles, the adsorbing material is capable of adsorbing dust and/or liquid residues, and the bristles are capable of removing solid residues and/or liquid residues.

In an embodiment, the bristles are radially disposed on the bracket.

In an embodiment, the bristles at least include the bristles of thermoplastic material and the bristles of adsorptive material.

In an embodiment, the thermoplastic material is selected from the group consisting of a thermoplastic plastic material and a thermoplastic rubber material. The adsorptive material is selected from the group consisting of foamed plastic, foamed rubber, natural fibers, synthetic fibers, and textile.

In an embodiment, the thermoplastic rubber material is selected from the group consisting of thermoplastic vulcanizate and thermoplastic polyurethane. The thermoplastic plastic material is selected from the group consisting of ethylene-vinyl acetate copolymer, polyethylene, polyvinyl chloride, polypropylene, polylactic acid, polystyrene, polyamide, polycarbonate, and polyurethane.

In an embodiment, the bracket is configured to circumferentially move along the inner wall of the accommodating cavity.

In an embodiment, the bracket is configured to circumferentially rotate along the inner wall of the accommodating cavity.

In an embodiment, the bracket is configured to circumferentially reciprocate along the inner wall of the accommodating cavity.

In an embodiment, the bracket is configured to reciprocally move along an axial direction of the accommodating cavity.

In an embodiment, a rotating shaft of the electric motor is parallel or perpendicular to the axial direction of the accommodating cavity.

In an embodiment, the tool is configured to be powered on by pressing.

In an embodiment, the tool further includes a brush head detachably and fixedly connected in the tool, wherein the brush head includes the bracket and the cleaning unit.

In an embodiment, the brush head further includes a substrate, the bracket protrudes from the substrate, the rotating shaft of the electric motor is fixedly connected to a mounting base, and the electric motor is configured to drive the substrate to move through the mounting base.

In an embodiment, the mounting base is provided with a fan blade structure configured to drive air to flow.

In an embodiment, the fan blade structure is configured to drive the air to flow away from the electric motor.

In an embodiment, the fan blade structure is configured to drive the air to flow towards the electric motor. A surface, adjacent to the fan blade structure, of the electric motor is provided with an adsorption layer.

In an embodiment, the tool further includes a control unit configured to detect whether the number of uses and/or a used time of the brush head exceeds a first preset value, and if so, send a signal indicating that the brush head needs to be replaced.

In an embodiment, the tool further includes a control unit configured to detect whether a friction between the brush head and the accommodating cavity is smaller than a second preset value, and if so, send a signal indicating that the brush head needs to be replaced.

In an embodiment, the tool further includes a probe configured to detect that the cleaning unit is damaged or has excessively accumulated dirt, and configured to send a signal indicating that the brush head needs to be replaced.

In an embodiment, the probe is a photosensitive probe and/or an acoustic probe.

In an embodiment, the tool further includes a signal emission source applied in conjunction with the probe.

In an embodiment, the bracket includes a first straight rod, a second straight rod, and an arcuate rod. The first straight rod and the second straight rod are both parallel to the axial direction of the accommodating cavity. The arcuate rod is connected between the first straight rod and the second straight rod. The first straight rod and the second straight rod protrude from the substrate. The arcuate rod is connected to ends, away from the substrate, of both the first straight rod and the second straight rod.

In an embodiment, the substrate is detachably connected to the mounting base through at least one of a snap-fit structure, screw threads, an interference fit, and a magnetic connection.

By implementing the present disclosure, following beneficial effects can be achieved. The deposits or residues are quickly cleaned by the tool for cleaning an electric heating smoking device while the heater is prevented from being damaged, which greatly reduces the time cost for cleaning and maintenance.

### BRIEF DESCRIPTION OF THE DRAWINGS

FIG. 1 is a schematic structural view of a tool for cleaning an electric heating smoking device in Embodiment 1.

FIG. 2 is a schematic structural view of a brush head in Embodiment 1.

FIG. 3 is a schematic structural, exploded view of the tool for cleaning the electric heating smoking device in Embodiment 1.

FIG. 4 is a schematic structural view of the brush head in Embodiment 2.

FIG. 5 is a schematic structural view of the brush head in Embodiment 3.

FIG. 6 is a schematic structural view of a mounting base in Embodiment 4.

FIG. 7 is a schematic structural view of the brush head driven by an electric motor in Embodiment 6.

FIG. 8 is a schematic structural view of the brush head driven by the electric motor in Embodiment 7.

FIG. 9 is a schematic structural view of the brush head driven by the electric motor in Embodiment 8.

### DETAILED DESCRIPTION

The contents of the present disclosure are specifically described below in conjunction with embodiments.

### Embodiment 1

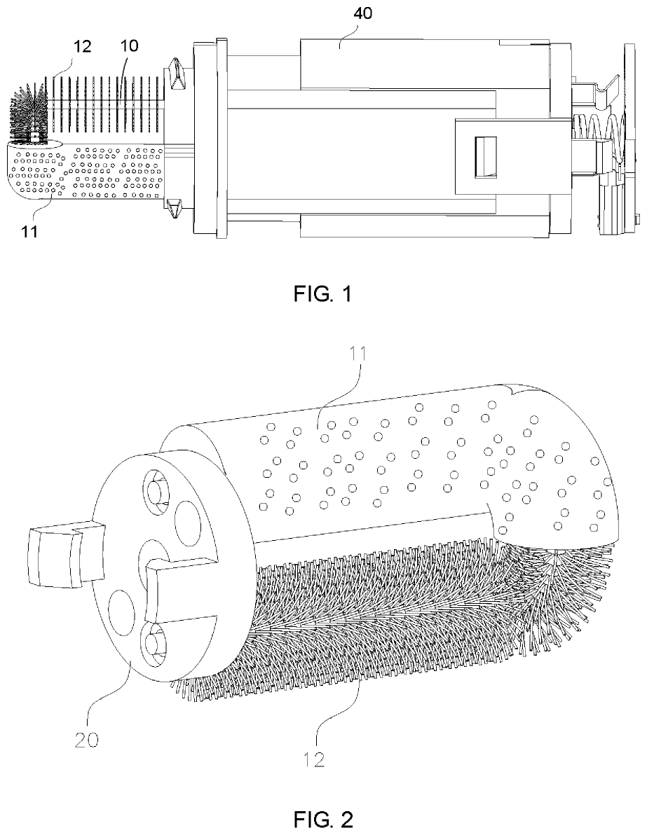

FIG. 1 is a schematic structural view of the tool for cleaning the electric heating smoking device in the present embodiment. As shown in FIG. 1, the tool includes a bracket 10, a cleaning unit, and an electric motor 40. The bracket 10 is configured to be inserted into an accommodating cavity. The cleaning unit is disposed on the bracket 10. The electric motor 40 is configured to drive the bracket 10 to move. The tool is configured to clean a smoking device with an elongated heater. For example, US patent application No. US2015136154A1 of Philip Morris Products S.A discloses a smoking article for use in an aerosol-generating device. The smoking article includes an aerosol-forming substrate located at an extreme upstream end of the smoking article and a support element located immediately downstream of the aerosol-forming substrate. The support element abuts the aerosol-forming substrate. The aerosol-forming substrate is configured to be penetrable by a heating element, of an aerosol-generating device, having a diameter of between about 40 percent and about 70 percent of the diameter of the aerosol-forming substrate without substantial deformation of the smoking article. The support element is configured to resist downstream movement of the aerosol-forming substrate during insertion of the heating element of the aerosol-generating device into the aerosol-forming substrate.

A smoking device used in conjunction with this kind of smoking article is described in the US patent application No. US2015163859A1 of Philip Morris Products S.A. A housing of the aerosol-generating device defines a cavity, a proximal end (or mouth end) of which is open to receive an aerosol-forming article for consumption. An aerosol-forming substrate is pushed inside the housing to come into thermal proximity with a heater. The heater is inserted into the aerosol-forming article. By controlling a maximum operation temperature of the electrically heated aerosol-generating system to be below a selected value, selected volatile compounds are released and release of undesirable compounds is controlled.

The tool of the present embodiment is suitable for cleaning an electric heating smoking device including an accommodating cavity for accommodating a smoking stick and an elongated heater to be inserted into the smoking stick from an end of the smoking stick for heating the smoking stick. In use, the brush head is inserted into the smoking stick accommodating cavity of the smoking device; and the bracket 10 circumferentially moves at a certain speed under the control of the electric motor 40. By selecting a specific material of the cleaning unit, the friction between the bristles 12 and the smoking device is controlled in an appropriate range, and a torque on the heater caused by the friction is controlled lower than a first preset value, in order to avoid damage to the heater due to the circumferential movement of the cleaning tool.

In addition, the torque output by the electric motor 40 is in an appropriate range. If the torque output by the electric motor 40 is too small, the cleaning effect and cleaning speed are not ideal; but if it is too high, the heater may be damaged.

In an embodiment, on the basis of the above-described embodiment, a rotating shaft 41 of the electric motor 40 is parallel to an extending direction of the heater. In a further embodiment, a rotating axis of the bracket 10 coincides with the rotating shaft 41 of the electric motor 40. The bracket 10 can move in two ways, one is that the bracket 10 circumferentially rotates along an inner wall of the accommodating cavity, that is, the electric motor 40 rotates 360 degrees in one direction only and also drives the bracket 10 to rotate 360 degrees in one direction only; the other way is that the bracket 10 circumferentially moves along the inner wall of the accommodating cavity, and by controlling the electric motor 40 to rotate periodically in forward and reverse directions, the bracket 10 oscillates in the accommodating cavity. The oscillation angle can be any angle smaller than 360 degrees.

FIG. 2 is a schematic structural view of an embodiment of the brush head. As shown in FIG. 2, the brush head includes a bracket 10 and a cleaning unit. In the present embodiment, the bracket 10 includes at least two types of cleaning units respectively made of different materials. One type of the cleaning unit is made of adsorbing material 11, such as foamed plastic, foamed rubber, natural fibers, synthetic fibers, textile, etc., wound or wrapped on the bracket 10 to form the cleaning unit with a cleaning function. This type of the cleaning unit is similar in shape to a head of a cotton swab. The material with the large specific surface area can be used to adsorb dust and/or liquid residues. Moreover, the cleaning unit in this type is relatively soft and has a good contractility, so that it can also have a relatively good cleaning effect on hard-to-reach corners. Another type of the cleaning unit is the bristles 12, which are radially arranged on the bracket 10 to form the cleaning unit with a cleaning function, and the bristles 12 achieve the cleaning purpose by friction caused by relative movement.

The cleaning unit can also be the bristles 12. The bristles 12 can include adsorptive material bristles 12 and thermoplastic material bristles 12. On the one hand, the adsorptive materials can clean up the remaining liquid in the smoking stick accommodating cavity, such as the oily liquid produced by heating the smoking material. On the other hand, the adsorptive materials itself can carry some cleaning solvent, such as 2-butoxyethanol, glycol ether, mineral oil, ethyl acetate, isopropanol, ethanol, isoamyl acetate, isoamyl butyrate, and ethyl hexanoate, to soften, dissolve, and/or decompose the deposits or residues, especially dirt that is difficult to clean, such as the residues formed and firmly adsorbed on the heater or the accommodating cavity after tar is heated, dried, and solidified. The deposits or residues are easy to fall off as the cleaning solvent weakens the adsorption force between the deposits or residues and the smoking device in combination with the friction caused by the rotation of the bristles 12, thereby achieving the purpose of cleaning. The thermoplastic material bristles 12 have greater hardness and elasticity than the adsorptive material bristles 12 and can generate greater friction than the adsorptive material bristles 12 during the circumferential movement, and the greater friction is easier to cause the residues to fall off. Two types of the bristles 12 used together can fully play their respective roles and remedy the shortcomings of a single type of the bristles 12, greatly enhancing the cleaning effect.

The thermoplastic materials include thermoplastic plastic materials and thermoplastic rubber materials; the adsorptive materials include foamed plastics, foamed rubbers, natural fibers, and synthetic fibers.

The thermoplastic rubber materials (TPR materials) include thermoplastic vulcanizate (TPV), thermoplastic polyurethanes (TPU).

The thermoplastic plastic materials include ethylene-vinyl acetate copolymer (EVA), polyethylene (PE), polyvinyl chloride (PVC), polypropylene (PP), polylactic acid (PLA), polystyrene (PS), polyamide (PA), polycarbonate (PC), polyurethane (PU).

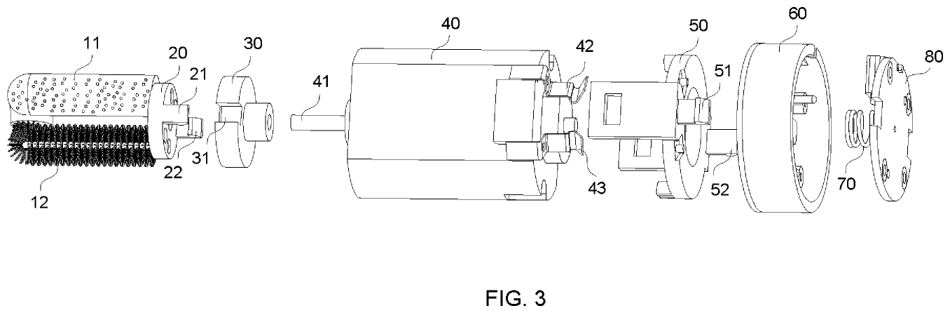

FIG. 3 is a schematic structural, exploded view of the tool for cleaning the electric heating smoking device in the present embodiment. As shown in FIG. 3, the tool includes a bracket 10, a first substrate 20, a mounting base 30, an electric motor 40, a second substrate 50, a limiting plate 60, a spring 70, and a circuit board 80.

The bracket 10 and the first substrate 20 are fixedly connected to each other. The mounting base 30 and the electric motor 40 are fixedly connected to each other. Through the detachable fixed connection between the first substrate 20 and the mounting base 30, the bristles 12 can be disassembled and replaced. The detachable connection between the first substrate 20 and the mounting base 30 can be at least one detachable connection of a snap-fit structure, screw threads, an interference fit, and a magnetic connection. FIG. 2 shows a snap-fit structure. A pair of hooks 21, 22 protrude from the first substrate 20, and snap-fit openings 31 for accommodating the pair of hooks 21, 22 are located on the mounting base 30. The hooks 21, 22 are made of thermoplastic elastomer plastic. In installation of the bracket 10, the locations of the hooks 21, 22 are in alignment with the snap-fit openings 31, so that the hooks 21 and 22 are inserted into the snap-fit openings 31 and fixed. When the bristles 12 need to be replaced, the bracket 10 can be pulled forcefully, so that the hooks 21, 22 are detached from the snap-fit openings 31. In the embodiment that the substrate is fixed to the mounting base 30 by screw threads, internal and external threads can be respectively disposed on the substrate and the mounting base 30, so that rotational fastening and disassembling can be achieved. In the embodiment that the substrate is fixed to the mounting base 30 by an interference fit, a plug and a socket can be respectively disposed on the substrate and the mounting base 30, so that plug-in fastening and disassembling can be achieved. In the embodiment that the substrate is fixed to the mounting base 30 by a magnetic connection, magnets can be respectively disposed on the substrate and the mounting base 30, so that magnetic coupling and separation can be achieved.

In an embodiment, on the basis of the above-described embodiment, the tool can be powered on by pressing. In an embodiment, a spring 70 is disposed between the electric motor 40 and the circuit board 80 to separate the electric motor 40 from the circuit board 80 for a certain distance; and elastic pieces are disposed on a power interface of the electric motor 40. When not in use, the elastic pieces are not in contact with the circuit board 80. When the smoking device abuts against any of the bracket 10, the substrate, and the electric motor 40 and pushes the electric motor 40 to move towards the circuit board 80, the elastic pieces become in contact with a positive electrode and a negative electrode of a power supply on the circuit board 80, so that a closed circuit is formed, and the electric motor 40 is powered on, driving the bracket 10 to circumferentially move, thereby driving the bristles 12 to clean the smoking device. The cleaning tool of the present disclosure is not limited to the above-described power-on method. In an embodiment, a pressure switch having a pressure sensor is applied to detect a pressure signal and output a control signal to realize the power-on and power-off control. Of course, it is also possible to directly connect the power interface of the electric motor 40 to the circuit board 80 through wires, and control the power-on and power-off of the cleaning tool by using a switch.

In an embodiment, on the basis of the above-described embodiment, the electric motor 40 and the second substrate 50 are fixedly connected to each other; the elastic pieces 42, 43 are disposed on the power interface of the electric motor 40; a pair of hooks 51, 52 protrude from the second substrate 50; and a limiting plate 60 respectively defines openings for the elastic pieces 42, 43 and the hooks 51, 52 to pass through. Once the electric motor 40 and the circuit board 80 are close enough, an electrical conduction can be formed between the electric motor 40 and the power supply by the elastic pieces 42, 43; the hooks 51, 52 passed through the openings on the limiting plate 60, on the one hand, prevent the electric motor 40 from detachment and limit the distance between the electric motor 40 and the circuit board 80, and, on the other hand, act as guide rails so that the electric motor 40 can slide only along the hooks 51, 52 during moving towards the circuit board 80. The elastic pieces 42, 43 can be made of metal material, which is electrically conductive and meanwhile has a certain degree of elasticity. The resilience of the elastic pieces 42, 43 ensures that the elastic pieces 42, 43 can work normally under different operating forces and have a relatively good operating feeling.

### Embodiment 2

As an alternative to Embodiment 1, the difference between the two embodiments is that the bracket 10 in the present embodiment only includes one type of the cleaning unit; that is, only the adsorbing material 11 that is capable of adsorbing dust and/or liquid residues is disposed on the bracket 10, or, only the bristles 12 are radially disposed on the bracket 10.

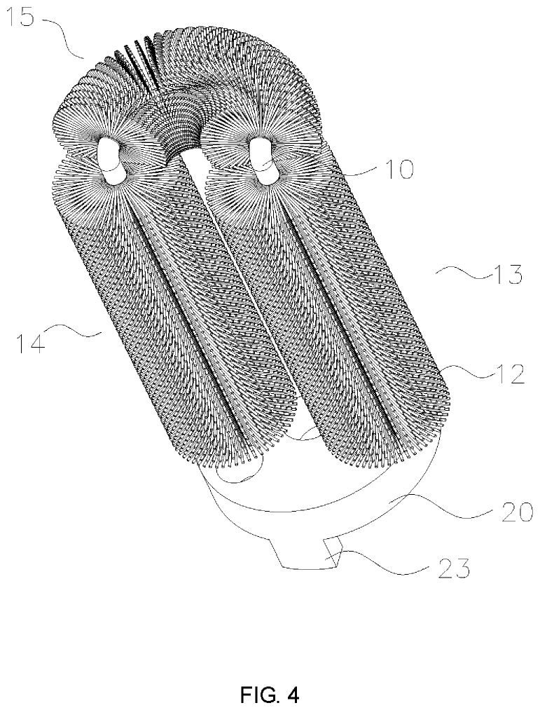

FIG. 4 is a schematic structural view of the brush head in Embodiment 2 of the present disclosure, showing the embodiment where only the bristles 12 are disposed on the bracket 10. The bristles 12 in the present embodiment can include one or both of the adsorptive material bristles 12 and the thermoplastic material bristles 12. The function of each type of the bristles 12 has been described in detail in Embodiment 1, and is not repeated herein. The detachable fixed connection between the first substrate 20 and the mounting base 30 (referring to FIG. 3) is different from the snap-fit structure shown in FIG. 2. In the present embodiment, extending protrusions 23 are disposed on the first substrate 20, and, correspondingly, grooves (not shown) are defined on the mounting base 30. Magnets are disposed respectively on the extending protrusions 23 and in the grooves. When the first substrate 20 is to be joined with the mounting base 30, the extending protrusions 23 are inserted into the grooves and be magnetically attached to the grooves. If there is a need to replace or remove the brush head, the first substrate 20 can be magnetically detached and separated from the mounting base 30 by applying an external force.

In an embodiment, the bracket 10 includes a first straight rod 13, a second straight rod 14, and an arcuate rod 15. The first straight rod 13 and the second straight rod 14 are both parallel to the axial extending direction of the heater. The arcuate rod 15 is connected between the first straight rod 13 and the second straight rod 14. The first straight rod 13 and the second straight rod 14 protrude from the substrate. In addition, the arcuate rod 15 is connected to the ends, away from the first substrate 20, of the first straight rod 13 and the second straight rod 14. The existence of the arcuate rod 15 allows the elongated heater to fall into the middle of the bracket 10 without contacting with the bracket 10. In operation of the cleaning tool of the present disclosure, the elongated heater is substantially parallel to the first straight rod 13 and the second straight rod 14, and the bristles 12 on the bracket 10 can clean the surface of the elongated heater and the inner wall of the smoking stick accommodating cavity during the movement thereof.

### Embodiment 3

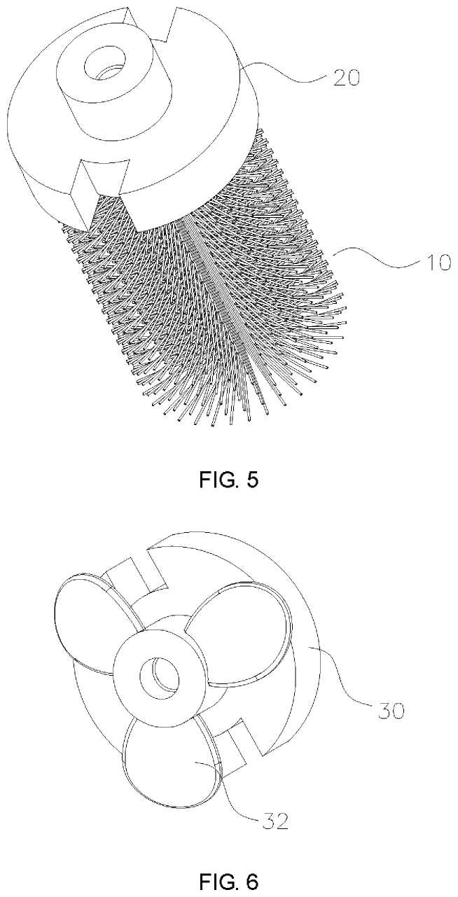

FIG. 5 is a schematic structural view of the brush head in Embodiment 3 of the present disclosure. As an alternative to Embodiment 1, the difference between the two embodiments is that the tool in the present embodiment is suitable for cleaning the electric heating smoking device with a tubular heater. The tubular heater itself defines the accommodating cavity for accommodating the smoking stick, and no elongated heater for heating the smoking stick is disposed in the accommodating cavity. The brush head of the present embodiment is inserted into the accommodating cavity to clean the inner wall of the cavity. In the present embodiment, the brush head includes at least one elongated bracket 10 and at least one type of the cleaning unit disposed on the bracket 10. Similar to the Embodiment 1, the cleaning unit can be made of adsorptive material, wound or covered on the bracket 10, similar in shape to the head of the cotton swab, or the cleaning unit can also be the bristles, which are radially arranged on the bracket 10. The bristles can also include at least one of the adsorptive material bristles and the thermoplastic material bristles. The specific materials and functions are similar to those in Embodiment 1, and are not repeated herein.

### Embodiment 4

FIG. 6 is a schematic structural view of the first substrate in the present embodiment. As an alternative to the mounting base in Embodiments 1 to 3, the difference between the two mounting bases is that the mounting base 30 in the present embodiment is also provided with a fan blade structure 32 configured to drive air to flow. The mounting base 30 is fixedly connected to the rotating shaft of the electric motor 40. In an embodiment, a through hole is defined on the mounting base 30 to accommodate the rotating shaft of the electric motor 40. The rotation of the electric motor 40 is transferred to the brush head through the mounting base 3. In the present embodiment, the fan blade structure 32 on the mounting base 30 rotates with the rotation of the electric motor 40 to drive the air-flow to blow up dust generated from the deposits, thereby improving the cleaning effect.

As an embodiment, the fan blade structure 32 drives the air to flow away from the electric motor 40. Under the cooperation between the blade direction of the fan blade structure 32 and the rotation direction of the electric motor 40, the air is blown out from the cleaning tool to prevent deposits of excessive dust on the cleaning unit.

As another embodiment, the fan blade structure 32 drives the air to flow towards the electric motor 40, so that the airborne dust flows towards the electric motor 40. A surface, adjacent to the fan blade structure 32, of the electric motor 40 is provided with an adsorption layer of porous materials, foamed materials, fiber materials, etc., to adsorb dust by using the relatively large specific surface area of the materials. For example, the porous materials are charcoal, activated carbon, etc.; the foamed materials are organic polymer materials that are prepared by foaming, such as sponge; the fiber materials are organic polymer materials that are spun into fibers, such as electrospun fibers.

### Embodiment 5

The present embodiment provides several implementations of a smart reminder for brush head replacement. In an embodiment, the cleaning tool includes a control unit configured to count the number of uses and/or a used time of one brush head. When the control unit detects that the number of uses and/or the used time of the brush head exceeds a first preset value, which means that the brush head has been overused, the control unit sends a signal indicating that the brush head needs to be replaced. The signal is in the form such as indicator light, alarm sound, etc.

In another embodiment, the cleaning tool further includes a control unit. When the control unit detects that a friction between the brush head and the accommodating cavity is smaller than a second preset value while the working conditions, such as the input current and voltage, of the electric motor are constant, which means that the brush head has been damaged very much, and the cleaning effect will be compromised if the brush head is continued to be used, the control unit sends a signal indicating that brush head needs to be replaced.

In another embodiment, the cleaning tool further includes a photosensitive probe to detect the damage of the cleaning unit or the excessive accumulation of dirt through a reflection, scattering, or transmission signal of emitted lights and to send the signal indicating that brush head needs to be replaced.

In another embodiment, the cleaning tool further includes an acoustic probe to detect the damage of the cleaning unit or the excessive accumulation of dirt through reflection of sound waves and to send the signal indicating that brush head needs to be replaced.

### Embodiment 6

As an alternative to Embodiment 1, the difference between the two embodiments is that in the present embodiment, the bracket 10 moves back and forth along the axial direction of the accommodating cavity.

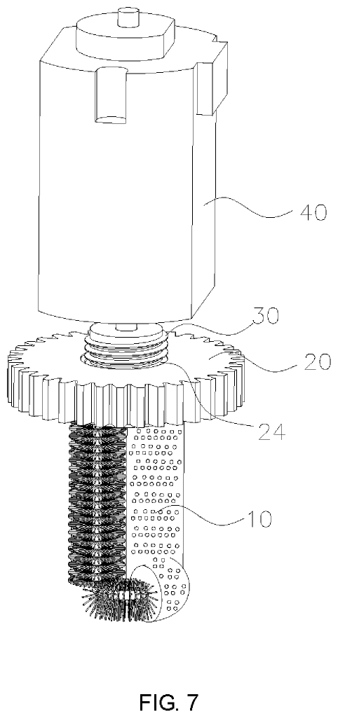

FIG. 7 is a schematic structural view of the brush head driven by the electric motor in the present embodiment. Similar to Embodiment 1, the rotating shaft of the electric motor 40 is parallel to the axial direction of the accommodating cavity. However, the rotation of the electric motor in the present embodiment is not converted into the circumferential movement of the bracket 10, but drives the bracket 10 to reciprocally move. In the present embodiment, the structure of the electric motor-driven brush head includes the bracket 10, the first substrate 20, the mounting base 30, and the electric motor 40. Similar to the Embodiment 1, the bracket 10 and the first substrate 20 are fixedly connected to each other, and the mounting base 30 and the electric motor 40 are fixedly connected to each other. The difference is that, in the present embodiment, the first substrate 20 is substantially disc-shaped, and a substantially cylindrical recess 24 is defined at a center position thereof. The mounting base 30 is also substantially cylindrical shaped. The recess 24 and the mounting base 30 are matched in size and have mutually mated threads; that is, an external thread is disposed on the surface of the mounting base 30, and an internal thread is disposed on the surface of the recess 24. By controlling the electric motor 40 to rotate in forward and reverse directions, the bracket 10 moves along the axial direction of the accommodating cavity. For example, the forward rotation of the electric motor 40 drives the first substrate 20 to move away from the electric motor 40, so that the bracket 10 moves along an entry direction of the accommodating cavity; and the reverse rotation of the electric motor 40 drives the first substrate 20 to move towards the electric motor 40, so that the bracket 10 moves along an exit direction of the accommodating cavity. The reciprocating movement of the brush head generates friction between the cleaning unit on the bracket 10 and the accommodating cavity or the heater in the accommodating cavity, thereby achieving the cleaning purpose.

### Embodiment 7

As an alternative to Embodiment 1, the difference between the two embodiments is that in the present embodiment, the bracket 10 moves back and forth along the axial direction of the accommodating cavity.

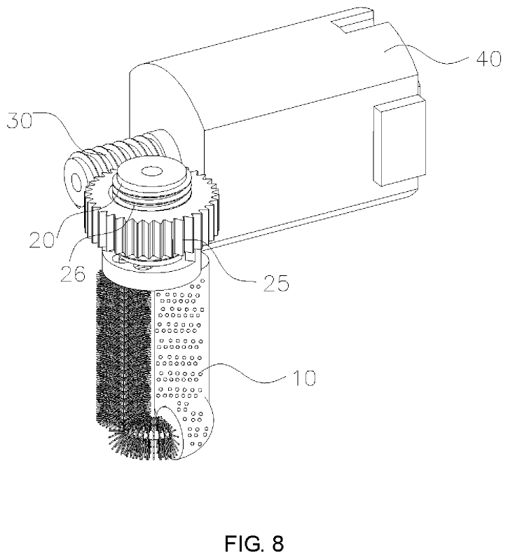

FIG. 8 is a schematic structural view of the brush head driven by the electric motor in the present embodiment. Different from that in Embodiment 1, the rotating shaft of the electric motor 40 is perpendicular to the axial direction of the accommodating cavity. The rotation of the electric motor in the present embodiment is not converted into the circumferential movement of the bracket 10, but drives the bracket 10 to reciprocally move. In the present embodiment, the structure of the electric motor-driven brush head includes the bracket 10, the first substrate 20, a transmission plate 25, the mounting base 30, and the electric motor 40. Similar to the Embodiment 1, the bracket 10 and the first substrate 20 are fixedly connected to each other, and the mounting base 30 and the electric motor 40 are fixedly connected to each other. The difference is that, in the present embodiment, the first substrate 20 is substantially cylindrical shaped, the transmission plate 25 is substantially disc-shaped, and a substantially cylindrical recess 26 is defined at a center position of the transmission plate 25. An external thread is disposed on an outer circumference of the transmission plate 25. The mounting base 30 is also substantially cylindrical shaped, and another external thread is disposed on an outer circumference of the mounting base 30. The external thread disposed on the outer circumference of the transmission plate 25 is mated with the external thread disposed on the outer circumference of the mounting base 30. Since the direction of the rotating axis of the mounting base 30 is perpendicular to the rotating axis of the transmission plate 25, the rotation direction is changed due to the thread transfer therebetween. The recess 26 and the first substrate 20 are matched in size and have mutually matched threads; that is, an external thread is disposed on the surface of the first substrate 20, and an internal thread is disposed on the surface of the recess 26.

By controlling the electric motor 40 to rotate in forward and reverse directions, the bracket 10 reciprocally moves along the axial direction of the accommodating cavity. For example, the forward rotation of the electric motor 40 drives the transmission plate 25 to rotate forwardly and further drives the first substrate 20 to move away from the electric motor 40, so that the bracket 10 moves along an entry direction of the accommodating cavity; and the reverse rotation of the electric motor 40 drives the transmission plate 25 to rotate reversely and further drives the first substrate 20 to move towards the electric motor 40, so that the bracket 10 moves along an exit direction of the accommodating cavity. The reciprocating movement of the brush head generates friction between the cleaning unit on the bracket 10 and the accommodating cavity or the heater in the accommodating cavity, thereby achieving the cleaning purpose.

### Embodiment 8

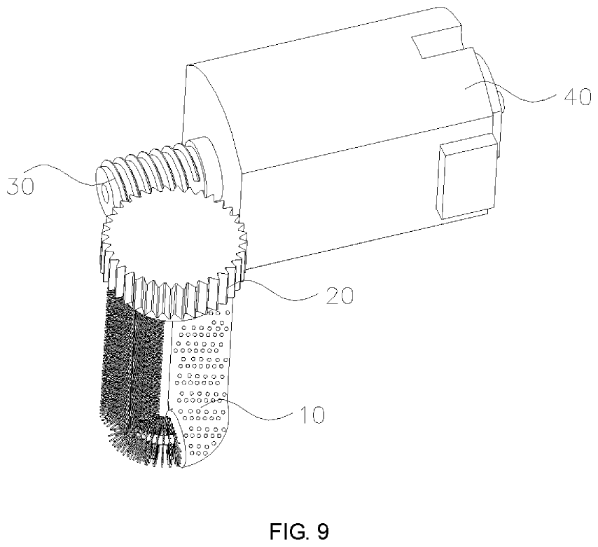

As an alternative to Embodiment 1, in the present embodiment, the bracket 10 circumferentially moves along the inner wall of the accommodating cavity, same as that in Embodiment 1. The difference between the two embodiments is that the rotating shaft of the electric motor 40 is perpendicular to the axial direction of the accommodating cavity. FIG. 9 is a schematic structural view of the brush head driven by the electric motor in the present embodiment. In the present embodiment, the rotation of the electric motor is converted into the circumferential movement of the bracket 10. However, the rotating shaft of the electric motor 40 is perpendicular to the axial direction of the accommodating cavity, so that there is a need to use threads to change the rotation direction. The structure of the electric motor-driven brush head includes the bracket 10, the first substrate 20, the mounting base 30, and the electric motor 40. Similar to Embodiment 1, the bracket 10 and the first substrate 20 are fixedly connected to each other, and the mounting base 30 and the electric motor 40 are fixedly connected to each other. The difference is that, in the present embodiment, the first substrate 20 is substantially disc-shaped, the mounting base 30 is substantially cylindrical shaped, and external threads are respectively disposed on outer circumferences of the first substrate 20 and the mounting base 30. The external thread disposed on the outer circumference of the first substrate 20 is mated with the external thread disposed on the outer circumference of the mounting base 30. Since the rotating axis of the mounting base 30 is perpendicular to the rotating axis of the first substrate 20, the rotation direction is changed due to the thread transfer therebetween. By controlling the rotation of the electric motor 40, the bracket 10 circumferentially moves, e.g., circumferentially rotates or circumferentially reciprocates, about the axial direction of the accommodating cavity. Specifically, the electric motor 40 continuously rotates in a single direction and also drives the first substrate 20 to continuously rotate in a single direction, thereby causing the brush head fixed on the first substrate 20 to rotate in the circumferential direction. When the movement of the electric motor 40 is in the manner of periodical forward and reverse rotations, the first substrate 20 is driven to make periodical forward and reverse rotations, so that the brush head fixed on the first substrate 20 circumferentially reciprocates along the inner wall of the accommodating cavity. The reciprocating movement of the brush head generates friction between the cleaning unit on the bracket 10 and the accommodating cavity or the heater in the accommodating cavity, thereby achieving the cleaning purpose.

The above embodiments further illustrate the contents of the present disclosure, but should not be construed as limiting the present disclosure. Without departing from the spirit and essence of the present disclosure, modifications and substitutions made to the methods, steps or conditions of the present disclosure all fall within the scope of the present disclosure. Unless particularly specified, the technical means used in the embodiments are conventional means well known to those skilled in the art.

1. A tool for cleaning an electric heating smoking device, the electric heating smoking device comprising an accommodating cavity, the tool comprising:
a bracket configured to be inserted into the accommodating cavity;
an electric motor configured to drive the bracket to move along an inner wall of the accommodating cavity; and
a cleaning unit disposed on the bracket.

2. The tool of claim 1, wherein the cleaning unit comprises at least one of an adsorbing material and bristles, the adsorbing material is capable of adsorbing dust and/or liquid residues, and the bristles are capable of removing solid residues and/or liquid residues.

3. The tool of claim 2, wherein the bristles are radially disposed on the bracket;
the bristles at least comprise the bristles of thermoplastic material and the bristles of adsorptive material;
the thermoplastic material is selected from the group consisting of a thermoplastic plastic material and a thermoplastic rubber material;
the adsorptive material is selected from the group consisting of foamed plastic, foamed rubber, natural fibers, synthetic fibers, and textile;
the thermoplastic rubber material is selected from the group consisting of thermoplastic vulcanizate and thermoplastic polyurethane;
the thermoplastic plastic material is selected from the group consisting of ethylene-vinyl acetate copolymer, polyethylene, polyvinyl chloride, polypropylene, polylactic acid, polystyrene, polyamide, polycarbonate, and polyurethane.

4-6. (canceled)

7. The tool of claim 1, wherein the bracket is configured to circumferentially move along the inner wall of the accommodating cavity.

8. The tool of claim 7, wherein the bracket is configured to circumferentially rotate along the inner wall of the accommodating cavity.

9. The tool of claim 7, wherein the bracket is configured to circumferentially reciprocate along the inner wall of the accommodating cavity.

10. The tool of claim 1, wherein the bracket is configured to reciprocally move along an axial direction of the accommodating cavity.

11. The tool of claim 7, wherein a rotating shaft of the electric motor is parallel or perpendicular to an axial direction of the accommodating cavity.

12. The tool of claim 11, wherein the tool is configured to be powered on by pressing, wherein
the tool further comprises a spring, a circuit board having a positive electrode and a negative electrode of a power supply, and elastic pieces; the spring is disposed between the electric motor and the circuit board to separate the electric motor from the circuit board; the elastic pieces are disposed on a power interface of the electric motor; on the condition that the tool is not in use, the elastic pieces are not in contact with the circuit board; on the condition that the smoking device abuts against any of the bracket, a substrate, and the electric motor and pushes the electric motor to move towards the circuit board, the elastic pieces become in contact with the positive electrode and the negative electrode of the power supply on the circuit board; or
the tool comprises a pressure switch having a pressure sensor, configured to detect a pressure signal and output a control signal to control power-on and power-off of the tool; or
the tool comprises a switch configured to control power-on and power-off of the tool, and the power interface of the electric motor is directly connected to the circuit board through wires.

13. The tool of claim 1, further comprising a brush head detachably and fixedly connected in the tool, wherein the brush head comprises the bracket and the cleaning unit.

14. The tool of claim 13, wherein the brush head further comprises a substrate, the bracket protrudes from the substrate, the rotating shaft of the electric motor is fixedly connected to a mounting base, and the electric motor is configured to drive the substrate to move through the mounting base.

15. The tool of claim 14, wherein the mounting base is provided with a fan blade structure configured to drive air to flow.

16. The tool of claim 15, wherein the fan blade structure is configured to drive the air to flow away from the electric motor.

17. The tool of claim 15, wherein the fan blade structure is configured to drive the air to flow towards the electric motor; and a surface, adjacent to the fan blade structure, of the electric motor is provided with an adsorption layer.

18. The tool of claim 13, further comprising a control unit configured to detect whether the number of uses and/or a used time of the brush head exceeds a first preset value, and if so, the control unit is configured to send a signal indicating that the brush head needs to be replaced.

19. The tool of claim 13, further comprising a control unit configured to detect whether a friction between the brush head and the accommodating cavity is smaller than a second preset value, and if so, the control unit is configured to send a signal indicating that the brush head needs to be replaced.

20. The tool of claim 13, further comprising a probe configured to detect that the cleaning unit is damaged or has excessively accumulated dirt, and configured to send a signal indicating that the brush head needs to be replaced, wherein the probe is a photosensitive probe and/or an acoustic probe.

21. (canceled)

22. The tool of claim 20, further comprising a signal emission source applied in conjunction with the probe.

23. The tool of claim 14, wherein the bracket comprises a first straight rod, a second straight rod, and an arcuate rod; the first straight rod and the second straight rod are both parallel to the axial direction of the accommodating cavity; the arcuate rod is connected between the first straight rod and the second straight rod; the first straight rod and the second straight rod protrude from the substrate; and the arcuate rod is connected to ends, away from the substrate, of both the first straight rod and the second straight rod.

24. The tool of claim 23, wherein the substrate is detachably connected to the mounting base through at least one of a snap-fit structure, screw threads, an interference fit, and a magnetic connection.
